(19) United States
(12) Patent Application Publication
(10) Pub. No.: US 2021/0249864 A1
(43) Pub. Date: Aug. 12, 2021

(54) HVDC TRANSMISSION SCHEMES

(71) Applicant: General Electric Technology GmbH, Baden (CH)

(72) Inventor: Anil Kumar UPADHYAY, Noida (IN)

(21) Appl. No.: 17/270,282

(22) PCT Filed: Aug. 14, 2019
(86) PCT No.: PCT/EP2019/071844

§ 371 Date: Feb. 22, 2021

(30) Foreign Application Priority Data
Aug. 24, 2018 (IN) 201841031731

(51) Int. Cl. H02J 3/36; H02H 7/26; H04B 7/08; H02H 7/125

(52) U.S. Cl. CPC H02J 3/36; H02H 7/268; H02H 3/05; H02H 7/125; H04B 7/08

(57) ABSTRACT

The present invention relates to a high voltage direct current (HVDC) transmission system (200) comprising a first bipole (210) comprising a first transmit station (220) and a first receive station (230) and a second bipole (250), connected to the first bipole (210), the second bipole (250) comprising a second transmit station (260) and a second receive station (270). The HVDC transmission system includes: a first HVDC transmission line (280) for coupling a negative node (2206) of the first transmit station (220) to a negative node (2306) of the first receive station (230); a second HVDC transmission line (290) for coupling a positive node (2208) of the first transmit station (220) to a positive node (2308) of the first receive station (230); a dedicated metallic return (DMR) (285, 295) for coupling a neutral node (2210a) of the first transmit station (220) to a neutral node (2310) of the first receive station (230).

### Field of the Invention

The present disclosure relates to systems and methods for transmission of high voltage direct current (HVDC) power.

### BACKGROUND OF THE INVENTION

High voltage direct current (HVDC) power transmission is a cost-effective way of transmitting electrical power over long distances, e.g. from generation centres to load centres or between two different regions. In HVDC systems alternating current (AC) electrical power is converted by an HVDC converter (rectifier) at a first station to HVDC electrical power for transmission over overhead or undersea cables to a destination. At the destination, the HVDC power is converted back to AC power by an HVDC converter (inverter) at a second station, for onward distribution to end-user sites via an electrical distribution network. The rating of an HVDC transmission scheme is based upon the power to be transferred between the two stations.

The first and second stations may be linked by a monopolar link, in which an electrically conductive (e.g. metallic) HVDC transmission line links a first live high-voltage (relative to ground), node of an HVDC converter of the first station to a corresponding first node of an HVDC converter of the second station, whilst a second node of the HVDC converter of the first station and a corresponding second node of the HVDC converter of the second station are connected to earth using earth electrodes. Thus, in this arrangement the earth acts as a return path for current. The second nodes of the HVDC converters of the first and second stations may also be connected by a second electrically conductive (e.g. metallic) transmission line, in which case the second transmission line provides a dedicated return path for current.

Alternatively, the first and second stations may be linked by a bipolar link. In a bipolar link two HVDC converters are connected in series in each of the first and second stations. A first electrically conductive (e.g. metallic) HVDC transmission line links a first live high-voltage (which is configured to be positive, relative to ground), node of a first HVDC converter of the first station to a corresponding first live high-voltage (also configured to be positive relative to ground), node of a first HVDC converter of the second station, forming a first pole of the system. A second electrically conductive (e.g. metallic) HVDC transmission line links a second live high-voltage (which is configured to be negative, relative to ground) node of a second HVDC converter of the first station to a corresponding second live high-voltage (also which is configured to be negative relative to ground) node of a second HVDC converter of the second station, forming a second pole of the system. Thus in this arrangement currents flowing in the first HVDC transmission line and the second HVDC transmission line are of opposite polarity. A third, neutral, node of the first station, which connects the first and second HVDC converters of the first station, is connected to earth, whilst a corresponding third, neutral, node of the second station, which connects the first and second HVDC converters of the second station, is also connected to earth. A current return path is also provided, either by an additional electrically conductive metallic transmission line known as a dedicated metallic return (DMR) that connects the third nodes of the first and second stations, or by a ground return, in which case earth electrodes are used to connect the third electrodes of the first and second stations to earth.

An advantage of a bipolar transmission system (also referred to herein as a bipole) is that in the event of a fault in one of the poles, the current return path (either earth or a DMR) can be used in place of the faulty pole, which allows the system to continue to operate, albeit at a reduced capacity, as a monopolar link. The system can subsequently be reconfigured to commutate current from the earth or DMR return path to the HVDC transmission line of the faulty pole, employing the HVDC transmission line of the faulty pole as a current return path. Thus the system can continue to operate as a monopolar link while the faulty pole is returned to service. In order to meet power transmission capacity and reliability requirements, it has been proposed to use systems in which two or more bipoles sharing common HVDC transmission lines are connected in parallel. The present disclosure relates to such a system.

### SUMMARY OF THE INVENTION

According to a first aspect, it is disclosed a high voltage direct current (HVDC) transmission system comprising: a first bipole comprising a first transmit station and a first receive station; a second bipole, connected in parallel with the first bipole, the second bipole comprising a second transmit station and a second receive station; a first HVDC transmission line for coupling a negative node of the first transmit station to a negative node of the first receive station; a second HVDC transmission line for coupling a positive node of the first transmit station to a positive node of the first receive station; a dedicated metallic return (DMR) for coupling a neutral node of the first transmit station to a neutral node of the first receive station, characterised in that the HVDC transmission system further comprises: a first negative HVDC bus coupled to a negative node of the second transmit station and to the first HVDC transmission line; a second negative HVDC bus coupled to a negative node of the second receive station and to the first HVDC transmission line; a first positive HVDC bus coupled to a positive node of the second transmit station and to the second HVDC transmission line; a second positive HVDC bus coupled to a positive node of the second receive station and to the second HVDC transmission line; a first neutral bus coupled to a neutral node of the second transmit station and to the DMR; a second neutral bus coupled to a neutral node of the second receive station and to the DMR; a ground return transfer switch (GRTS) coupled at a first terminal to the first neutral bus, wherein a second terminal of the GRTS is selectively connectable to the negative node of the first transmit station or to the positive node of the first transmit station; and a metallic return transfer breaker (MRTB) coupled at a first terminal to the first neutral bus and at a second terminal to the DMR, wherein the GRTS and the MRTB are operable to commutate return current in the first and second bipoles from the DMR to the first or second HVDC transmission line.

The HVDC transmission system may further comprise a neutral bus ground switch (NBGS) having a first terminal coupled to the first neutral bus and a second terminal configured to be coupled to earth.

The first transmit station may comprise a first link coupled at a first end to the negative node of the first transmit station and at a second end to the positive node of the first transmit station, wherein the first link comprises first and second link switches, and wherein the GRTS is coupled to the first link at a node intermediate the first and second link switches.

The first receive station may comprise a second link coupled at a first end to the negative node of the first receive station and at a second end to the positive node of the first receive station, wherein the second link comprises third and fourth link switches, and wherein the neutral node is coupled to the second link at a node intermediate the third and fourth link switches.

The first and second transmit stations may each comprise two series-connected HVDC converters.

The series-connected HVDC converters may be configured to operate as rectifiers.

The first and second receive stations may each comprise two series-connected HVDC converters.

The series-connected HVDC converters may be configured to operate as inverters. According to a second aspect, there is provided a transmit station for a HVDC transmission system, the transmit station comprising: a negative node configured to be coupled to a first HVDC transmission line; a positive node configured to be coupled to a second HVDC transmission line; a neutral node configured to be coupled to a DMR; a ground return transfer switch (GRTS) configured to be coupled at a first terminal to a first neutral bus, wherein a second terminal of the GRTS is selectively connectable to the negative node of the first transmit station or to the positive node of the first transmit station; and a metallic return transfer breaker (MRTB) configured to be coupled at a first terminal to the first neutral bus and at a second terminal to the DMR.

The HVDC transmission system for which the transmit station is provided may comprise the previously disclosed features.

The transmit station may further comprise a neutral bus ground switch (NBGS) having a first terminal coupled to the first neutral bus and a second terminal configured to be coupled to earth.

The transmit station may further comprising a first link coupled at a first end to the negative node and at a second end to the positive node, wherein the first link comprises first and second link switches, and wherein the GRTS is coupled to the first link at a node intermediate the first and second link switches.

The transmit station may further comprise a neutral bus ground switch (NBGS) having a first terminal coupled to the first neutral bus and a second terminal configured to be coupled to earth.

The transmit station may comprise first and second series-connected HVDC converters.

The first and second series-connected HVDC converters may be configured to operate as rectifiers.

According to a third aspect, there is provided a method for reconfiguring the HVDC transmission system of the first aspect, the method comprising: while operating the first and second bipoles in a monopole mode with one of the first and second HVDC transmission lines acting as a forward current path and the DMR acting as a return current path, detecting a fault to ground in the DMR; performing a forced retard operation on the pole comprising the one of the first and second HVDC transmission lines acting as the forward current path; closing the GRTS; after closing the GRTS, opening the MRTB; commutating return current from the DMR to the other of the first and second HVDC transmission lines that is not acting as the forward current path.

### BRIEF DESCRIPTION OF THE DRAWINGS

Embodiments of the invention will now be described, strictly by way of example only, with reference to the accompanying drawings, of which:

FIG. 1 is a schematic representation of an HVDC transmission system comprising two bipoles connected in parallel;

FIG. 2 is a schematic representation of an HVDC transmission system having two bipoles connected in parallel and sharing common buses and common commutation switchgears; and

FIG. 3 is a flow diagram illustrating steps in a method performed by the system of FIG. 2.

### DETAILED DESCRIPTION

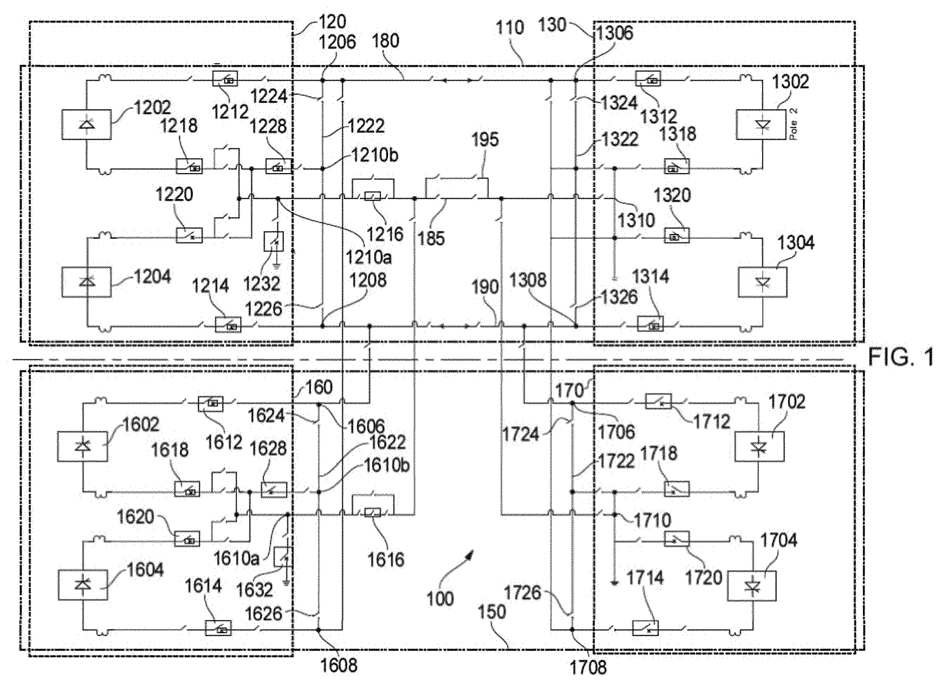

As discussed above, in order to meet power transmission capacity and reliability requirements, systems in which a plurality of bipoles sharing common HVDC transmission lines are connected in parallel have been proposed. One such system is shown generally at 100 in FIG. 1.

The system 100 of FIG. 1 comprises a first bipole 110 and a second bipole 150 connected in parallel with the first bipole 110. The first bipole 110 comprises a first transmit station 120 which includes series-connected first and second HVDC converters 1202, 1204, which in this example are configured as rectifiers for converting high voltage AC, e.g. from a generation centre, to high voltage DC for transmission to a remote receive station.

The first bipole 110 further comprises a first receive station 130 which includes series-connected third and fourth HVDC converters 1302, 1304, which in this example are configured as inverters for converting received high voltage DC to high voltage AC for onward transmission, for example to a load centre.

A first node 1206 (which is configured to be negative with respect to earth) of the first transmit station 120 is coupled, via a first HVDC transmission line 180, to a corresponding first node 1306 (which is also configured to be negative with respect to earth) of the first receive station 130.

A second node 1208 (which is configured to be positive with respect to earth) of the first transmit station 120 is coupled, via a second, positive, HVDC transmission line 190, to a corresponding second node 1308 (which is also configured to be positive with respect to earth) of the first receive station 130.

A first neutral node 1210a of the first transmit station 120, between a positive terminal of the first HVDC converter 1202 and a negative terminal of the second HVDC converter 1204, is coupled, via a parallel combination of a first dedicated metallic return (DMR) 185 and a second DMR 195, to a neutral node 1310 between a positive terminal of the third HVDC converter 1302 and a negative terminal of the fourth HVDC converter 1304 of the first receive station 130.

The first HVDC converter 1202, the third HVDC converter 1302 and the first HVDC transmission line 180 form a first pole of the first bipole 110, whilst the second HVDC converter 1204, the fourth HVDC converter 1304 and the second HVDC transmission line 190 form a second pole of the first bipole 110.

A first high-voltage, high-speed (HVHS) switch 1212 is provided in the first transmit station 120 between a negative terminal of the first HVDC converter 1202 and the first node 1206. By means of the first HVHS switch 1212 the first HVDC converter 1202 can be selectively coupled to or decoupled from the first HVDC transmission line 180. Thus, in the event of a fault in the first pole of the first bipole 110 (e.g. a fault in either the first HVDC converter 1202 or the third HVDC converter 1302), the first HVDC converter 1202 can be isolated from the first HVDC transmission line 180.

A second HVHS switch 1214 is provided in the first transmit station 120 between a positive terminal of the second HVDC converter 1204 and the second node 1208. By means of the second HVHS switch 1214 the second HVDC converter 1204 can be selectively coupled to or decoupled from the second HVDC transmission line 190. Thus, in the event of a fault in second pole of the first bipole 110 (e.g. a fault in either the second HVDC converter 1204 or the fourth HVDC converter 1304), the second HVDC converter 1204 can be isolated from the second HVDC transmission line 190.

The first transmit station 120 includes first and second neutral break switches (NBS) 1218, 1220 connected in series between the positive terminal of the first HVDC converter 1202 and the negative terminal of the second HVDC converter 1204.

A first link 1222 having first and second link switches 1224, 1226 extends between the first node 1206 and the second node 1208 of the first transmit station 120. A first Ground Return Transfer Switch (GRTS) 1228 is coupled at a first end to a second neutral node 1210b which is disposed between the positive terminal of the first HVDC converter 1202 and the negative terminal of the second HVDC converter 1204, and at a second end to the first link 1222 at a node intermediate the first and second link switches 1224, 1226.

A first terminal of a first Neutral Bus Grounding Switch (NGBS) 1232 is connected to the first neutral node 1210a, and a second terminal of the first NGBS 1232 is connected to earth. As indicated above and shown in FIG. 1, the first neutral node 1210a is coupled to the first and second DMRs 185, 195, and thus the first NGBS 1232 is also coupled to the first and second DMRs 185, 195. In the event of a fault in one or both of the first and second DMRs 185, 195, the NGBS can be closed to couple the affected DMR(s) 185, 195 to earth in order to clear the fault.

The first link 1222, first and second link switches 1224, 1226 and first GRTS permit the first node 1206 and the second node 1208 to be selectively coupled to the first neutral node 1210a, for example in the event of a fault in one of the poles of the first bipole 110, so as to utilise either the first or second HVDC transmission line 180, 190 and instead establish a current return path via the parallel combination of the first and second DMRs 185, 195, and vice versa.

Further, the first link 1222, first and second link switches 1224, 1226 and first NBS 1218 can be used in conjunction with the first HVHS switch 1212 to isolate the first HVDC converter 1202 and couple the first HVDC transmission line 180 to the second HVDC converter 1204, to permit the use of the first HVDC transmission line 180 as a current return path, for example in the event of a fault in the first pole of the first bipole 110. Similarly, the first link 1222, first and second link switches 1224, 1226 and second NBS 1220 can be used in conjunction with the second HVHS switch 1214 to isolate the second HVDC converter 1204 and couple the second HVDC transmission line 190 to the first HVDC converter 1202, to permit the use of the second HVDC transmission line 190 as a current return path, for example in the event of a fault in the second pole of the first bipole 110.

The first bipole includes a first Metallic Return Transfer Breaker (MRTB) 1216, connected in series between the first neutral node 1210a of the first transmit station 120 and the parallel combination of the first and second DMRs 185, 195. The first MRTB 1216 can be closed in order to couple the first neutral node 1210a to the parallel combination of the first and second DMRs 185, 195 so as to selectively couple either the first HVDC converter 1202 or the second HVDC converter 1204 to the parallel combination of the first and second DMRs 185, 195 (depending on the open/close state of the first and second NBSs 1218, 1220), for example in the event of a fault in the first bipole 110.

A third HVHS switch 1312 is provided in the first receive station 130 between a negative terminal of the third HVDC converter 1302 and the first node 1306. By means of the third HVHS switch 1312 the negative terminal of the third HVDC converter 1302 can be selectively coupled to or decoupled from the first HVDC transmission line 180.

A fourth HVHS switch 1314 is provided in the first receive station 130 between a positive terminal of the fourth HVDC converter 1304 and the second node 1308. By means of the fourth HVHS switch 1314 the positive terminal of the fourth HVDC converter 1304 can be selectively coupled to or decoupled from the second HVDC transmission line 190.

The first receive station 130 includes a third neutral break switch (NBS) 1318 connected in series between the neutral node 1310 and the positive terminal of the third HVDC converter 1302 and a fourth NBS 1320 connected in series between the neutral node 1310 and the negative terminal of the fourth HVDC converter 1304.

A second link 1322 having third and fourth link switches 1324, 1326 extends between the first node 1306 and the second node 1308 of the first receive station 130. The neutral node 1310 is coupled to the second link 1322 at a node intermediate the third and fourth link switches 1324, 1326. The neutral node 1310 is also coupled to ground. The second link 1322 and the third and fourth link switches 1324, 1326 permit the first node 1306 and the second node 1308 to be selectively coupled to neutral node 1310, for example in the event of a fault in the first or second pole of the first bipole 110, so as to utilise either the first or second HVDC transmission line 180, 190 and instead establish a either a ground return path for current or a current return path through the parallel combination of the first and second DMRs 185, 195 and vice versa.

Additionally, the second link 1322 and the third and fourth link switches 1324, 1326 can be used in conjunction with the third HVHS switch 1312 and the third NBS 1318 to isolate the third HVDC 1302 converter and couple the first HVDC transmission line 180 to the fourth HVDC converter 1304, to permit the use of the first HVDC transmission line 180 as a current return path, for example in the event of a fault in the first pole of the first bipole 110. Similarly, the second link 1322 and the third and fourth link switches 1324, 1326 can be used in conjunction with the fourth HVHS switch 1314 and the fourth NBS 1320 to isolate the fourth HVDC converter 1304 and couple the second HVDC transmission line 190 to the third HVDC converter 1302, to permit the use of the second HVDC transmission line 190 as a current return path, for example in the event of a fault in the second pole of the first bipole 110.

The second bipole 150 is generally similar to the first bipole, and comprises a second transmit station 160 which includes series-connected fifth and sixth HVDC converters 1602, 1604, which in this example are configured as rectifiers for converting high voltage AC, e.g. from a generation centre, to high voltage DC for transmission to a remote receive station.

The second bipole 150 further comprises a second receive station 170 which includes series-connected seventh and eighth HVDC converters 1702, 1704, which in this example are configured as inverters for converting received high voltage DC to high voltage AC for onward transmission, for example to a load centre.

The fifth HVDC converter 1602, the seventh HVDC converter 1702 and the second HVDC transmission line 190 form a first pole of the second bipole 150, whilst the sixth HVDC converter 1604, the eighth HVDC converter 1704 and the first HVDC transmission line 180 form a second pole of the second bipole 150.

A first node 1606 (which is configured to be positive with respect to earth) of the second transmit station 160 is coupled, via the second HVDC transmission line 190, to a corresponding first node 1706 (which is also configured to be positive with respect to earth) of the second receive station 170.

A second node 1608 (which is configured to be negative with respect to earth) of the second transmit station 160 is coupled, via the first HVDC transmission line 180, to a corresponding second node 1708 (which is also configured to be negative with respect to earth) of the second receive station 170.

A first neutral node 1610a of the second transmit station 160, between a positive terminal of the fifth HVDC converter 1602 and a negative terminal of the sixth HVDC converter 1604, is coupled, via the parallel combination of the first dedicated metallic return (DMR) 185 and the second DMR 195, to a neutral node 1710 between a positive terminal of the seventh HVDC converter 1702 and a negative terminal of the eighth HVDC converter 1704 of the second receive station 170.

Thus, the first and second HVDC transmission lines 180, 190 and the parallel combination of the first and second DMRs 185, 195 are common to both the first bipole 110 and the second bipole 150.

A fifth high-voltage, high-speed (HVHS) switch 1612 is provided in the second transmit station 160 between a positive terminal of the fifth HVDC converter 1602 and the first node 1606. By means of the fifth HVHS switch 1612 the positive terminal of the fifth HVDC converter 1602 can be selectively coupled to or decoupled from the second, positive, HVDC transmission line 190.

A sixth HVHS switch 1614 is provided in the second transmit station 160 between a negative terminal of the sixth HVDC converter 1604 and the second node 1608. By means of the sixth HVHS switch 1614 the negative terminal of the sixth HVDC converter 1604 can be selectively coupled to or decoupled from the first, negative, HVDC transmission line 180.

The second transmit station 160 includes fifth and sixth neutral break switches (NBS) 1618, 1620 connected in series between the positive terminal of the fifth HVDC converter 1602 and the negative terminal of the seventh HVDC converter 1604.

A third link 1622 having fifth and sixth link switches 1624, 1626 extends between the first node 1606 and the second node 1608 of the second transmit station 160. A second Ground Return Transfer Switch (GRTS) 1628 is coupled at one end to a second neutral node 1610b, disposed between the positive terminal of the fifth HVDC converter 1602 and the negative terminal of the sixth HVDC converter 1604, and at the other end to the third link 1622.

A first terminal of a second Neutral Bus Grounding Switch (NGBS) 1632 is connected to the first neutral node 1610a, and a second terminal of the second NGBS 1632 is connected to the earth.

The third link 1622, fifth and sixth link switches 1624, 1626, and second NBGS 1632 permit the first node 1606 and the second node 1608 to be selectively coupled to earth, for example in the event of a fault in one of the poles of the second bipole 150, so as to bypass either the first or second HVDC transmission line 180, 190 and instead establish a ground return path for current.

Additionally, the third link 1622, fifth and sixth link switches 1624, 1626, and second GRTS 1628 permit the first node 1606 and the second node 1608 to be selectively coupled to neutral node 1610a, for example in the event of a fault in one of the poles of the second bipole 150, so as to utilise either the first or second HVDC transmission line 180, 190 and instead establish a current return path via the parallel combination of the first and second DMRs 185, 195 and vice versa.

Further, the third link 1622, fifth and sixth link switches 1624, 1626 and fifth NBS 1618 can be used in conjunction with the fifth HVHS switch 1612 to isolate the fifth HVDC converter 1602 and couple the first HVDC transmission line 180 to the sixth HVDC converter 1604, to permit the use of the first HVDC transmission line 180 as a current return path, for example in the event of a fault in the first pole of the second bipole 150. Similarly, the third link 1622, fifth and sixth link switches 1624, 1626 and sixth NBS 1620 can be used in conjunction with the second HVHS switch 1614 to isolate the sixth HVDC converter 1604 and couple the second HVDC transmission line 190 to the fifth HVDC converter 1602, to permit the use of the second HVDC transmission line 190 as a current return path, for example in the event of a fault in the second pole of the second bipole 150.

The second bipole 150 includes a second Metallic Return Transfer Breaker (MRTB) 1616, connected in series between the first neutral node 1610a of the second transmit station 160 and the parallel combination of the first and second DMRs 185, 195. The second MRTB 1616 can be closed in order to couple the first neutral node 1610a to the parallel combination of the first and second DMRs 185, 195 so as to selectively couple either the fifth HVDC converter 1602 or the sixth HVDC converter 1604 to the parallel combination of the first and second DMRs 185, 195 (depending on the open/close state of the fifth and sixth NBSs 1618, 1620), for example in the event of a fault in the second bipole 150.

A seventh HVHS switch 1712 is provided in the second receive station 170 between a negative terminal of the HVDC third converter 1702 and the first node 1706. By means of the seventh HVHS switch 1712 the positive terminal of the seventh HVDC converter 1702 can be selectively coupled to or decoupled from the second, positive, HVDC transmission line 190.

An eighth HVHS switch 1714 is provided in the second receive station 170 between a negative terminal of the eighth HVDC converter 1704 and the second node 1708. By means of the eighth HVHS switch 1714 the negative terminal of the eighth HVDC converter 1704 can be selectively coupled to or decoupled from the first HVDC transmission line 180.

The second receive station 170 includes a seventh neutral break switch (NBS) 1718 connected in series between the neutral node 1710 and the negative terminal of the seventh HVDC converter 1702 and an eighth NBS 1720 connected in series between the neutral node 1710 and the positive terminal of the eighth HVDC converter 1704.

A fourth link 1722 having seventh and eighth link switches 1724, 1726 extends between the first node 1706 and the second node 1708 of the second receive station 170. The neutral node 1710 is coupled to the fourth link 1722 at a node intermediate the seventh and eighth link switches 1724, 1726. The neutral node 1710 is also coupled to earth.

The fourth link 1722 and seventh and eighth link switches 1724, 1726 permit the first node 1706 and the second node 1708 to be selectively coupled to neutral node 1710, for example in the event of a fault in the first or second pole of the second bipole 150, so as to utilise either the first or second HVDC transmission line 180, 190 and instead establish either a ground return path for current or a current return path through the parallel combination of the first and second DMRs 185, 195 and vice versa.

Additionally, the fourth link 1722 and the seventh and eighth link switches 1724, 1726 can be used in conjunction with the seventh HVHS switch 1712 and the seventh NBS 1718 to isolate the seventh HVDC converter 1702 and couple the second HVDC transmission line 190 to the eighth HVDC converter 1704, to permit the use of the second HVDC transmission line 190 as a current return path, for example in the event of a fault in the first pole of the second bipole 150. Similarly, the fourth link 1722 and the seventh and eighth link switches 1724, 1726 can be used in conjunction with the eighth HVHS switch 1714 and the eighth NBS 1720 to isolate the eighth HVDC converter 1704 and couple the first HVDC transmission line 180 to the seventh HVDC converter 1702, to permit the use of the first HVDC transmission line 180 as a current return path, for example in the event of a fault in the second pole of the second bipole 150.

As will be appreciated from the discussion above, in the system 100 of FIG. 1, the first and second bipoles 110, 150 each have their own commutation switchgear (NBGSs 1232, 1632, GRTSs 1228, 1628 and MRTBs 1216, 1616) for commutating return current between the DMRs 185, 195 and the HVDC transmission lines 180, 190.

In monopole operation of the system 100, both of the bipoles 110, 150 operate in parallel, with the DMRs 185, 195 being used as the return path for return current. In the event of a line to ground fault on one of the DMRs 185, 195, the NBGS 1232 of the first bipole 110 and the NBGS 1632 of the second bipole 150 must be closed in order to clear the fault. Simultaneously closing the NBGS 1232 of the first bipole 110 and the NBGS 1632 of the second bipole 150 is not possible however, and thus one of the two NGBS 1232, 1632 must be closed before the other. Such a situation would result in unequal current distribution between a pole in the first bipole 110 and a corresponding pole (having the same polarity) in the second bipole 150, e.g. an unequal current distribution between the first pole of the first bipole 110 and the second pole of the second bipole 150. The NBGS 1232, 1632 selected to be closed first may not have a sufficiently high current rating to be able to handle the return current from both of the bipoles 110, 150 resulting from such a situation. In this situation, a forced retard technique is used to increase the delay angle of the HVDCs 1302, 1704 before the NGBS 1232 or 1632 is closed and restarts are attempted, in order to reduce the return current to a level that can be handled by the selected NGBS 1232, 1632. If the fault persists, return current through the DMRs 185, 195 is commutated from the DMRs 185, 195 to one of the HVDC transmission lines 180, 190. For this to happen the GRTS 1228 and the GRTS 1628 must be closed before the MRTBs 1216, 1616 can be opened. Closing both the GRTS 1228 and the GRTS 1628 simultaneously is not practically possible, and thus the GRTS 1228 and the GRTS 1628 must be closed in sequence, which increases the delay before normal power flow can be restored.

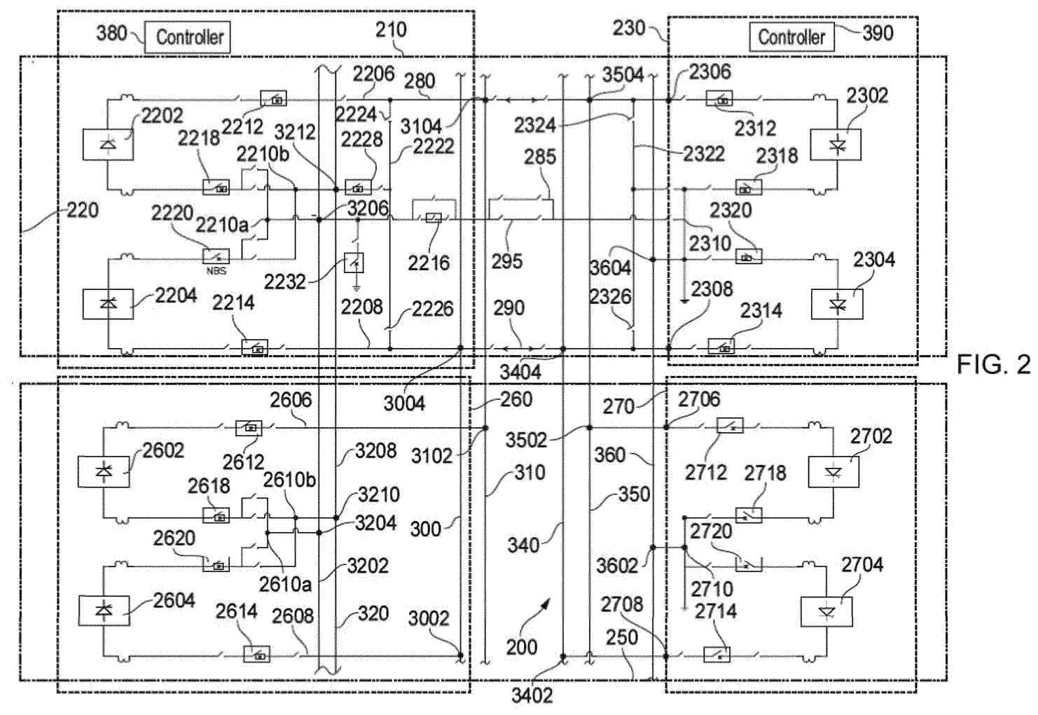

Referring now to FIG. 2, an HVDC transmission system with parallel bipoles and common positive and negative HVDC buses and a common neutral LVDC bus is shown generally at 200.

The system 200 includes a first bipole 210 and a second bipole 250 connected in parallel with the first bipole 210.

The system 200 further includes a first positive HVDC bus 300, a first negative HVDC bus 310 and a first neutral LVDC bus 320 that are common to both the first and second bipoles 210, 250. The system 200 further includes a second positive HVDC bus 340, a second negative HVDC bus 350 and a second neutral LVDC bus 360 that are common to both the first and second bipoles 210, 250.

The first bipole 210 comprises a first transmit station 220 which includes series-connected first and second HVDC converters 2202, 2204, which in this example are configured as rectifiers for converting high voltage AC, e.g. from a generation centre, to high voltage DC for transmission to a remote receive station.

The first bipole 210 further comprises a first receive station 230 which includes series-connected third and fourth HVDC converters 2302, 2304, which in this example are configured as inverters for converting received high voltage DC to high voltage AC for onward transmission, for example to a load centre.

A first node 2206 (which is configured to be negative with respect to earth) of the first transmit station 220 is coupled, via a first HVDC transmission line 280, to a corresponding first node 2306 (which is also configured to be negative with respect to earth) of the first receive station 230.

A second node 2208 (which is configured to be positive with respect to earth) of the first transmit station 220 is coupled, via a second HVDC transmission line 290, to a corresponding second node 2308 (which is also configured to be positive with respect to earth) of the first receive station 230.

A first neutral node 2210a of the first transmit station 220, between a positive terminal of the first HVDC converter 2202 and a negative terminal of the second HVDC converter 2204, is coupled, via a parallel combination of a first dedicated metallic return (DMR) 285 and a second DMR 295, to a neutral node 2310 between a positive terminal of the third HVDC converter 2302 and a negative terminal of the fourth HVDC converter 2304 of the first receive station 230.

The first HVDC converter 2202, the third HVDC converter 2302 and the first HVDC transmission line 280 form a first pole of the first bipole 210, whilst the second HVDC converter 2204, the fourth HVDC converter 2304 and the second HVDC transmission line 290 form a second pole of the first bipole 210.

A first high-voltage, high-speed (HVHS) switch 2212 is provided in the first transmit station 220 between a negative terminal of the first HVDC converter 2202 and the first node 2206. By means of the first HVHS switch 2212 the first HVDC converter 2202 can be selectively coupled to or decoupled from the first HVDC transmission line 280. Thus, in the event of a fault in the first pole of the first bipole 210 (e.g. a fault in either the first HVDC converter 2202 or the third HVDC converter 2302), the first HVDC converter 2202 can be isolated from the first HVDC transmission line 280.

A second HVHS switch 2214 is provided in the first transmit station 220 between a positive terminal of the second HVDC converter 2204 and the second node 2208. By means of the second HVHS switch 2214 the second HVDC converter 2204 can be selectively coupled to or decoupled from the second HVDC transmission line 290. Thus, in the event of a fault in second pole of the first bipole 210 (e.g. a fault in either the second HVDC converter 2204 or the fourth HVDC converter 2304), the second HVDC converter 2204 can be isolated from the second HVDC transmission line 290.

The first transmit station 220 includes first and second neutral break switches (NBS) 2218, 2220 connected in series between the positive terminal of the first HVDC converter 2202 and the negative terminal of the second HVDC converter 2204.

A first link 2222 having first and second link switches 2224, 2226 extends between the first node 2206 and the second node 2208 of the first transmit station 220. A Ground Return Transfer Switch (GRTS) 2228 is coupled, at a first end, to a second neutral node 2210b, which disposed between the positive terminal of the first HVDC converter 2202 and the negative terminal of the second HVDC converter 2204, and, at a second end, to the first link 2222, at a node intermediate the first and second link switches 2224, 2226.

A first terminal of a Neutral Bus Grounding Switch (NGBS) 2232 is connected to the first neutral node 2210a, and a second terminal of the first NGBS 2232 is connected to earth. As indicated above and shown in FIG. 2, the first neutral node 2210a is coupled to the first and second DMRs 285, 295, and thus the first NGBS 2232 is also coupled to the first and second DMRs 285, 295. In the event of a fault in one or both of the first and second DMRs 285, 295, the NGBS can be closed to couple the affected DMR(s) 285, 295 to earth in order to clear the fault.

The first link 2222, first and second link switches 2224, 2226 and first GRTS permit the first node 2206 and the second node 2208 to be selectively coupled to the first neutral node 2210a, for example in the event of a fault in one of the poles of the first bipole 210, so as to utilise either the first or second HVDC transmission line 280, 290 and instead establish a current return path via the parallel combination of the first and second DMRs 285, 295 and vice versa.

Additionally, the first link 2222, first and second link switches 2224, 2226 and first NBS 2218 can be used in conjunction with the first HVHS switch 2212 to isolate the first HVDC converter 2202 and couple the first HVDC transmission line 280 to the second HVDC converter 2204, to permit the use of the first HVDC transmission line 280 as a current return path, for example in the event of a fault in the first pole of the first bipole 210. Similarly, the first link 2222, first and second link switches 2224, 2226 and second NBS 2220 can be used in conjunction with the second HVHS switch 2214 to isolate the second HVDC converter 2204 and couple the second HVDC transmission line 290 to the first HVDC converter 2202, to permit the use of the second HVDC transmission line 290 as a current return path, for example in the event of a fault in the second pole of the first bipole 210.

The first pole 210 includes a Metallic Return Transfer Breaker (MRTB) 2216, connected in series between the first neutral node 2210a of the first transmit station 220 and the parallel combination of the first and second DMRs 285, 295. The MRTB 2216 can be closed in order to couple the first neutral node 2210a to the parallel combination of the first and second DMRs 285, 295 so as to selectively couple either the first HVDC converter 2202 or the second HVDC converter 2204 to the parallel combination of the first and second DMRs 285, 295 (depending upon the open/close state of the first and second NBSs 2218, 2220), for example in the event of a fault in the first bipole 210.

A third HVHS switch 2312 is provided in the first receive station 230 between a negative terminal of the third converter 2302 and the first node 2306. By means of the third HVHS switch 2312 the negative terminal of the third HVDC converter 2302 can be selectively coupled to or decoupled from the first, negative, HVDC transmission line 280.

A fourth HVHS switch 2314 is provided in the first receive station 230 between a positive terminal of the fourth HVDC converter 2304 and the second node 2308. By means of the fourth HVHS switch 2314 the positive terminal of the fourth HVDC converter 2304 can be selectively coupled to or decoupled from the second, positive, HVDC transmission line 290.

The first receive station 230 includes a third neutral break switch (NBS) 2318 connected in series between the neutral node 2310 and the positive terminal of the third HVDC converter 2302 and a fourth NBS 2320 connected in series between the neutral node 2310 and the negative terminal of the fourth HVDC converter 2304.

A second link 2322 having third and fourth link switches 2324, 2326 extends between the first node 2306 and the second node 2308 of the first receive station 230. The neutral node 2310 is coupled to the second link 2322 at a node intermediate the third and fourth link switches 2324, 2326. The neutral node 2310 is also coupled to earth. The second link 2322, and third and fourth link switches 2324, 2326 permit the first node 2306 and the second node 2308 to be selectively coupled to neutral node 2310, for example in the event of a fault in one of the poles of the first bipoles 210 so as to utilise either the first or second HVDC transmission line 280, 290 and instead establish a current return path via the parallel combination of the first and second DMRs 185, 195 and vice versa.

Additionally, the second link 2322, and the third and fourth link switches 2324, 2326 can be used in conjunction with the third HVHS switch 2312 and the third NBS 2318 to isolate the third HVDC converter 2302 and couple the first HVDC transmission line 280 to the fourth HVDC converter 2304, to permit the use of the first HVDC transmission line 280 as a current return path, for example in the event of a fault in the first pole of the first bipole 210. Similarly, the second link 2322, and third and fourth link switches 2324, 2326 can be used in conjunction with the fourth HVHS switch 2314 and the fourth NBS 2320 to isolate the fourth HVDC converter 2304 and couple the second HVDC transmission line 290 to the third HVDC converter 2302, to permit the use of the second HVDC transmission line 290 as a current return path, for example in the event of a fault in the second pole of the first bipole 210.

The second bipole 250 comprises a second transmit station 260 which includes series-connected fifth and sixth HVDC converters 2602, 2604, which in this example are configured as rectifiers for converting high voltage AC, e.g. from a generation centre, to high voltage DC for transmission to a remote receive station.

The second bipole 250 further comprises a second receive station 270 which includes series-connected seventh and eighth HVDC converters 2702, 2704, which in this example are configured as inverters for converting received high voltage DC to high voltage AC for onward transmission, for example to a load centre.

A first node 2606 (which is configured to be negative with respect to earth) of the second transmit station 260 is coupled, at a first negative HVDC bus node 3102 to the first negative HVDC bus 310, which is in turn coupled to the first HVDC transmission line 280 at a second negative HVDC bus node 3104.

A first node 2706 (which is also configured to be negative with respect to earth) of the second receive station 270 is coupled to the second negative HVDC bus 350 at a third negative HVDC bus node 3502, which is in turn coupled to the first HVDC transmission line 280 at a fourth negative HVDC bus node 3504.

Thus, the first node 2606 of the second transmit station 260 can be coupled to the first node 2706 of the second receive station 270 by the first HVDC transmission line 280, via the first and second negative HVDC buses 310, 350.

A second node 2608 (which is configured to be positive with respect to earth) of the second transmit station 260 is coupled, at a first positive HVDC bus node 3002, to the first positive HVDC bus 300, which is in turn coupled to the second, positive HVDC transmission line 290 at a second positive HVDC bus node 3004.

A second node 2708 (which is also configured to be positive with respect to earth) of the second receive station 270 is coupled to the second positive HVDC bus 340 at a third positive HVDC bus node 3402, which is in turn coupled to the second, positive HVDC transmission line 290 at a fourth positive HVDC bus node 3404.

Thus, the second node 2606 of the second transmit station 260 can be coupled to the second node 2706 of the second receive station 270 by the second HVDC transmission line 290, via the first and second positive HVDC buses 300, 340.

The fifth HVDC converter 2602, the seventh HVDC converter 2702 and the first HVDC transmission line 280 form a first pole of the second bipole 250, whilst the sixth HVDC converter 2604, the eighth HVDC converter 2704 and the second HVDC transmission line 290 form a second pole of the second bipole 250.

A fifth high-voltage, high-speed (HVHS) switch 2612 is provided in the second transmit station 260 between a negative terminal of the fifth HVDC converter 2602 and the first node 2606. By means of the fifth HVHS switch 2612 the negative terminal of the fifth HVDC converter 2602 can be selectively coupled to or decoupled from the first, negative, HVDC transmission line 280.

A sixth HVHS switch 2614 is provided in the second transmit station 260 between a positive terminal of the sixth HVDC converter 2604 and the second node 2608. By means of the sixth HVHS switch 2614 the positive terminal of the sixth HVDC converter 2604 can be selectively coupled to or decoupled from the second, positive, HVDC transmission line 290.

The second transmit station 260 includes fifth and sixth neutral break switches (NBS) 2618, 2620 connected in series between the positive terminal of the fifth HVDC converter 2602 and the negative terminal of the sixth HVDC converter 2604.

A first neutral node 2610a of the second transmit station 260 is coupled to a first line 3202 of the first LVDC neutral bus 320 at a first LVDC neutral bus node 3204. A second LVDC neutral bus node 3206 couples the first line 3202 of the first LVDC neutral bus 320 to the first neutral node 2210a of the first transmit station 220. A second neutral node 2610b of the second transmit station 260 is coupled to a second line 3208 of the first LVDC neutral bus 320 at a third LVDC neutral bus node 3210. A fourth LVDC neutral bus node 3212 couples the second line 3208 of the first LVDC neutral bus 320 to the second neutral node 2210b of the first transmit station 220.

The second receive station 270 includes a seventh neutral break switch (NBS) 2718 connected in series between the neutral node 2710 and the positive terminal of the seventh HVDC converter 2702 and an eighth NBS 2720 connected in series between the neutral node 2710 and the negative terminal of the eighth HVDC converter 2704.

A neutral node 2710 of the second receive station 270 is coupled to the second LVDC neutral bus 360 at a fifth LVDC neutral bus node 3602. The second LVDC neutral bus is coupled to the neutral node 2310 of the first receive station at a sixth LVDC neutral bus node 3604.

Thus, the first and second neutral nodes 2610a, 2610b of the second transmit station 260 can be coupled to the neutral node 2710 of the second receive station 270 by the parallel combination of the first and second DMRs 285, 295, via the first and second lines 3202, 3204 of the first LVDC neutral bus 320 and the second LVDC neutral bus 360.

As will be apparent from the discussion above, in contrast with the system 100 of FIG. 1, the first and second bipoles 210, 250 of the system 200 do not each have their own commutation switchgear for commutating return current between the DMRs 285, 295 and the HVDC transmission lines 280, 290.

Instead, the MRTB 2216, GRTS 2228 and NBGS 2232 are common to both the first and second bipoles 210, 250 and are shared through the use of the first and second LVDC neutral buses 320, 360. This arrangement thus requires fewer components than the system 100 of FIG. 1, since the second MRTB 1616, the second GRTS 1628 and the second NBGS 1632 and are not required. The system 200 of FIG. 2 is therefore simpler than the system 100 of FIG. 1, and does not suffer from the above-described problems of coordinating switching of the switchgear of the first and second bipoles and of unequal current distribution between the switchgear of the first and second bipoles.

For example, consider a situation in which the first and second bipoles 210, 250 are operating in a monopole mode using the first HVDC transmission line 280 as a forward current path and the DMRs 285, 295 are being used as the return current path. In this situation the first pole of the first bipole 210 and the first pole of the second bipole 250 are coupled to the first HVDC transmission line 280. In the event of a persistent line to ground fault in one of the DMRs 285, 295, a forced retard operation is performed in both of the poles that are coupled to the first HVDC transmission line 280 in order to reduce return current to a manageable level. The common GRTS 2228 is then closed before the MRTB 2216 is opened to commutate return current from the DMRs 285, 295 to the second HVDC transmission line 290.

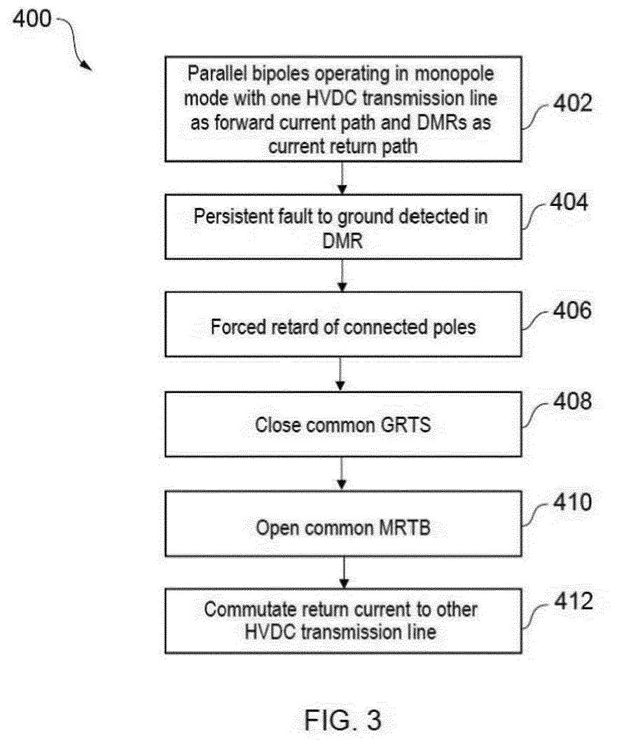

Referring to FIG. 3, a method performed by one or more controllers 380, 390 of the HVDC transmission system of FIG. 2 is shown generally at 400

At step 402, the parallel first and second bipoles 210, 260 of the system 200 are operating in a monopole mode with one of the first and second HVDC transmission lines 280, 290 being used as a forward current path and the DMRs 285, 295 being used as the return current path.

At step 404, a persistent line to ground fault is detected in one or both of the DMRs 285, 295, requiring commutation of return current to the other of the first and second HVDC transmission lines 280, 290.

At step 406 a forced retard procedure is performed in the active poles of the first and second bipoles 210, 260 (i.e. the poles that are coupled to the HVDC transmission line 280, 290 that is being used as the forward current path) to reduce the return current to a level that can be handled by the common GRTS 2228.

At step 408 the common GRTS 2228 is closed, and at step 410 the common MRTB is opened, to commutate current from the DMR to the other of the first and second HVDC transmission lines 280. 290.

As will be appreciated from the foregoing description, the system 200 and method 400 provide a simple and cost-effective mechanism for commutating return current to an HVDC transmission line in a HVDC transmission system that uses two parallel bipoles. Those skilled in the art will appreciate that the system and method can be extended to employ more than two parallel bipoles.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality. Any reference signs in the claims shall not be construed so as to limit their scope.

1-15. (canceled)

16. A high voltage direct current (HVDC) transmission system comprising:
a first bipole comprising a first transmit station and a first receive station;
a second bipole connected in parallel with the first bipole, the second bipole comprising a second transmit station and a second receive station;
a first HVDC transmission line for coupling a negative node of the first transmit station to a negative node of the first receive station;
a second HVDC transmission line for coupling a positive node of the first transmit station to a positive node of the first receive station;
a dedicated metallic return (DMR) for coupling a neutral node of the first transmit station to a neutral node of the first receive station;
a first negative HVDC bus coupled to a negative node of the second transmit station and to the first HVDC transmission line;
a second negative HVDC bus coupled to a negative node of the second receive station and to the first HVDC transmission line;
a first positive HVDC bus coupled to a positive node of the second transmit station and to the second HVDC transmission line;
a second positive HVDC bus coupled to a positive node of the second receive station and to the second HVDC transmission line;
a first neutral bus coupled to a neutral node of the second transmit station and to the DMR;
a second neutral bus coupled to a neutral node of the second receive station and to the DMR;
a ground return transfer switch (GRTS) coupled at a first terminal to the first neutral bus, wherein a second terminal of the GRTS is selectively connectable to the negative node of the first transmit station or to the positive node of the first transmit station; and
a metallic return transfer breaker (MRTB) coupled at a first terminal to the first neutral bus and at a second terminal to the DMR,
wherein the GRTS and the MRTB are operable to commutate return current in the first and second bipoles from the DMR to the first or second HVDC transmission line

17. The HVDC transmission system according to claim 16, further comprising a neutral bus ground switch (NBGS) having a first terminal coupled to the first neutral bus and a second terminal configured to be coupled to earth.

18. The HVDC transmission system according to claim 16, wherein the first transmit station comprises a first link coupled at a first end to the negative node of the first transmit station and at a second end to the positive node of the first transmit station, wherein the first link comprises first and second link switches, and wherein the GRTS is coupled to the first link at a node intermediate the first and second link switches.

19. The HVDC transmission system according to claim 18, wherein the first receive station comprises a second link coupled at a first end to the negative node of the first receive station and at a second end to the positive node of the first receive station, wherein the second link comprises third and fourth link switches, and wherein the neutral node is coupled to the second link at a node intermediate the third and fourth link switches.

20. The HVDC transmission system according to claim 16, wherein the first and second transmit stations each comprise two series-connected HVDC converters.

21. The HVDC transmission system according to claim 20, wherein the series-connected HVDC converters are configured to operate as rectifiers.

22. The HVDC transmission system according to claim 20, wherein the first and second receive stations each comprise two series-connected HVDC converters.

23. The HVDC transmission system according to claim 22, wherein the series-connected HVDC converters are configured to operate as inverters.

24. A transmit station for a HVDC transmission system, the transmit station comprising:
a negative node configured to be coupled to a first HVDC transmission line;
a positive node configured to be coupled to a second HVDC transmission line;
a neutral node configured to be coupled to a DMR;
a ground return transfer switch (GRTS) configured to be coupled at a first terminal to a first neutral bus, wherein a second terminal of the GRTS is selectively connectable to the negative node of the first transmit station or to the positive node of the first transmit station; and
a metallic return transfer breaker (MRTB) configured to be coupled at a first terminal to the first neutral bus and at a second terminal to the DMR,

25. The transmit station according to claim 24, further comprising a neutral bus ground switch (NBGS) having a first terminal coupled to the first neutral bus and a second terminal configured to be coupled to earth.

26. The transmit station according to claim 24, further comprising a first link coupled at a first end to the negative node and at a second end to the positive node, wherein the first link comprises first and second link switches, and wherein the GRTS is coupled to the first link at a node intermediate the first and second link switches.

27. The transmit station according to claim 24, further comprising a neutral bus ground switch (NBGS) having a first terminal coupled to the first neutral bus and a second terminal configured to be coupled to earth.

28. The transmit station according to claim 24, wherein the transmit station comprises first and second series-connected HVDC converters.

29. The transmit station according to claim 28 wherein the first and second series-connected HVDC converters are configured to operate as rectifiers.

30. A method for reconfiguring the HVDC transmission system of claim 16, the method comprising:
while operating the first and second bipoles in a monopole mode with one of the first and second HVDC transmission lines acting as a forward current path and the DMR acting as a return current path, detecting a fault to ground in the DMR;
performing a forced retard operation on the pole comprising the one of the first and second HVDC transmission lines acting as the forward current path;
closing the GRTS;
after closing the GRTS, opening the MRTB; and
commutating return current from the DMR to the other of the first and second HVDC transmission lines that is not acting as the forward current path.
